(19) United States
(12) Patent Application Publication
(10) Pub. No.: US 2014/0216331 A1
(43) Pub. Date: Aug. 7, 2014

(54) EDIBLE PELLET PRODUCING APPARATUS

(71) Applicant: LONG CHANG, Tustin, CA (US)

(72) Inventor: LONG CHANG, Tustin, CA (US)

(73) Assignee: LONG CHANG, Tustin, CA (US)

(21) Appl. No.: 13/761,355

(22) Filed: Feb. 7, 2013

(51) Int. Cl. A23P 1/08

(52) U.S. Cl. CPC A23P 1/082
USPC 118/20

(57) ABSTRACT

An edible pellet producing apparatus and an operation method are provided. The edible pellet producing apparatus includes a solidifying device, a processing chamber, a boiling tank and a cooling tank for producing an edible pellet.

### FIELD OF THE INVENTION

The present disclosure generally relates to a pellet producing apparatus. More particularly, it relates to an edible pellet producing apparatus, and a method for operating such an apparatus.

### BACKGROUND OF THE INVENTION

Bubble tea is also known as pearl milk tea, “boba” milk tea, “boba” tea, tapioca tea, pearl tea, milk tea, bubble drink, “zhen zhu nai cha”, or tapioca pearl drink, which is originated from Taiwan, the Formosa Island, and is a kind of authentic Taiwan-flavor food. The bubble tea is usually made of adding a mass of small chewy tapioca balls into the fresh cool tea, such as the black tea. The tapioca ball is also known as “boba” or “zhen zhu” directly based on its Chinese pronunciation.

Typically, tapioca balls are massively produced by a large-scaled instrument in food industrial ingredient factories. The finished tapioca balls are well packaged and sold to the ordinary consumers through the retail market. Therefore, subject to the requirement of the large-scaled instrument, it seems impossible for an ordinary end consumer to make the tapioca balls at home or at any place for convenience, not to mention having food safety and health control in production. In addition, the factory-produced tapioca balls are commonly in raw and required to be well cooked before being eaten.

There is a need to solve the above deficiencies/issues. For example, there might need a relatively light and small-scaled device capable of producing the tapioca balls and well cooking the finished tapioca balls at home or any place for convenience for an ordinary consumer.

### SUMMARY OF THE INVENTION

In an edible pellet producing apparatus, the edible pellet producing apparatus includes a solidifying device and a processing chamber. The solidifying device is configured to process a plurality of edible ingredients into a moistened solid core. The processing chamber has a slide chute, which is configured to receive the moistened solid core, and provide an environment with a plurality of pulverized edible ingredients therein, and cause the moistened solid core to pass through the environment via the slide chute.

In an edible pellet producing apparatus, the edible pellet producing apparatus includes a filling device and a processing chamber. The filling device provides a granule. The processing chamber is configured to process the granule into an edible pellet.

### BRIEF DESCRIPTION OF THE DRAWINGS

FIG. 1a is a schematic diagram illustrating a filling device in accordance with the present disclosure.

FIG. 1b is a cross-sectional view of a cap in FIG. 1a taken along the AA′ line in accordance with the present disclosure.

FIG. 2a is a schematic diagram illustrating a processing device in accordance with the present disclosure.

FIG. 2b is a schematic diagram illustrating a tubular barrel in accordance with the present disclosure.

FIG. 3 is a schematic diagram illustrating a boiling tank and a cooling tank in accordance with the present disclosure.

FIGS. 4a-4d are schematic diagrams illustrating operations of a funnel-shaped channel in accordance with the present disclosure.

FIGS. 5a-5e are schematic diagrams illustrating operations of a funnel-shaped channel in accordance with the present disclosure.

### DETAILED DESCRIPTION OF THE PREFERRED EMBODIMENT

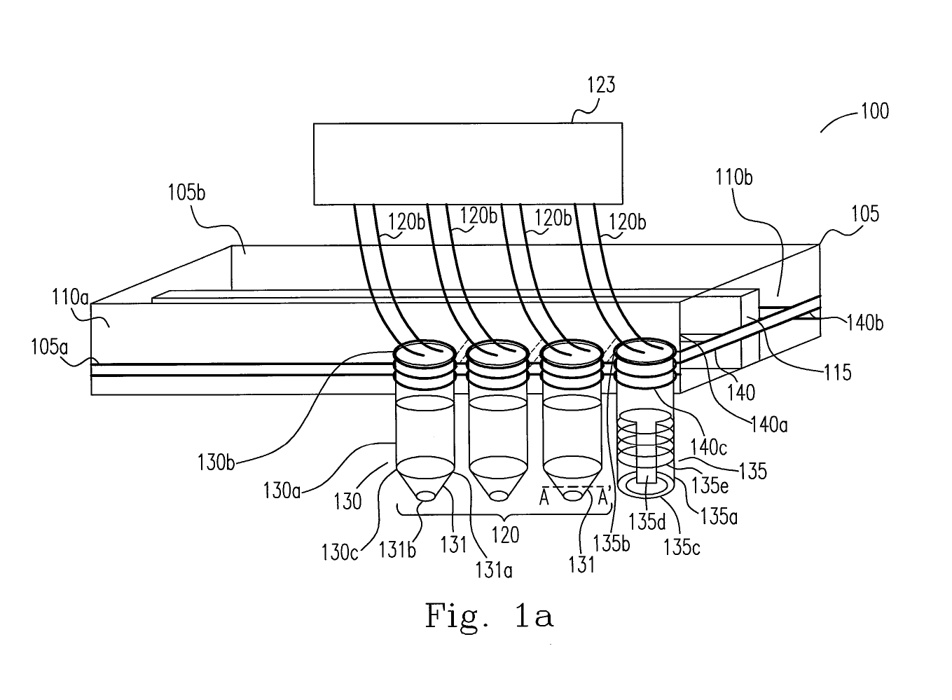

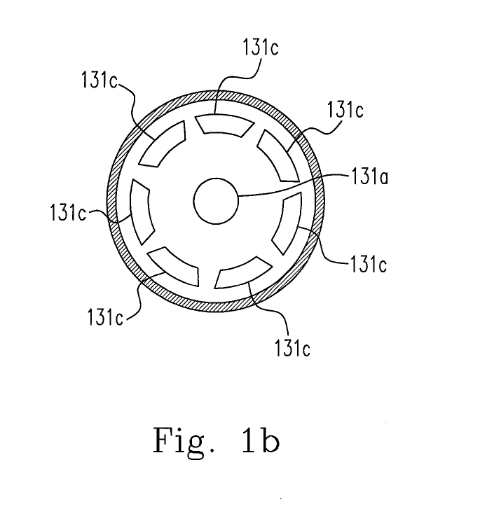

The disclosure will now be described by a detailed description of several embodiments. Referring now to FIGS. 1a to 5e, an edible pellet producing apparatus in accordance with various embodiments of the present disclosure is shown.

FIG. 1a is a schematic diagram illustrating a filling device in accordance with the present disclosure. In FIG. 1a, a filling device 100 includes a gear box 105 having a first sidewall 105a and a second sidewall 105b, a first motion track 110a formed on the first sidewall 105a, a second motion track 110b formed on the second sidewall 105b, a motion gear 115, an air pump 123 and a filling module 120 coated with nano-particles. The gear box 105 is a main body of the filling device 100 for affixing the other component parts. The filling module 120 includes an ingredient injector 130 having an inside wall coated with nano-particles, an air injector 135 and a plurality of latches 140. The ingredient injector 130 and the air injector 135 are affixed to the gear box 105 by the plurality of latches 140 through holding rings 140c. For example, a first end of the plurality of latches 140a is affixed by the first motion track 110a and a second end of the plurality of latches 140b is affixed by the second motion track 110b. It should be noted that each of the plurality of latches 140 is movable, in particular, on the first motion track 110a and the second motion track 110b.

In certain embodiments of the invention, the filling device 100 includes two or more filling module 120 and the filling module 120 includes two, three, or more ingredient injector 130

As shown in FIG. 1a, the motion gear 115 is programmed to systematically move the ingredient injector 130 and the air injector 135 on the first motion track 110a and the second motion track 110b. For example, since the ingredient injector 130 and the air injector 135 are affixed by the plurality of latches 140 and the plurality of latches 140 are affixed by the motion gear 115, the ingredient injector 130 and the air injector 135 can be controlled by the motion gear 115.

In certain embodiments of the invention, there are a plurality of air hoses 120b configured perform a connection between the air pump 123 and one of the ingredient injector 130 and the air injector 135 and the like.

According to certain embodiments of the invention, the ingredient injector 130 includes a cylinder 130a having a first opening 130b and a second opening 130c, and a cap 131 having a first opening 131a and a second opening 131b. The first opening 130b is connected to the one of the plurality of air hoses 120b, as described therein. The first opening 131a can be screwed onto the second opening 130c.

FIG. 1b is a cross-sectional view of a cap in FIG. 1a taken along the AA′ line in accordance with the present disclosure. In FIG. 1b, the cap 131, for example, is conical and includes a plurality of slots 131c disposed around the first opening 131a.

According to certain embodiments of the invention, the air injector 135 is configured to provide a compressed air. The air injector 135 includes a cylinder 135a having a first opening 135b and a second opening 135c. The cylinder 135a includes a plunger 135d and a coil spring 135e. The first opening 135b is connected to the one of the plurality of air hoses 120b, as described therein. In some embodiments, the cylinder 135a is filled by an air supplied from the air pump 123, the coil spring 135e is compressed and the plunger 135d is subsequently pushed out via the second opening 135c, and the coil spring 135e pull the plunger 135d back when being released.

According to certain embodiments of the invention, one of the ingredient injector 130 and the air injector 135 can disassemble from the filling module 120 for filling ingredients and cleaning.

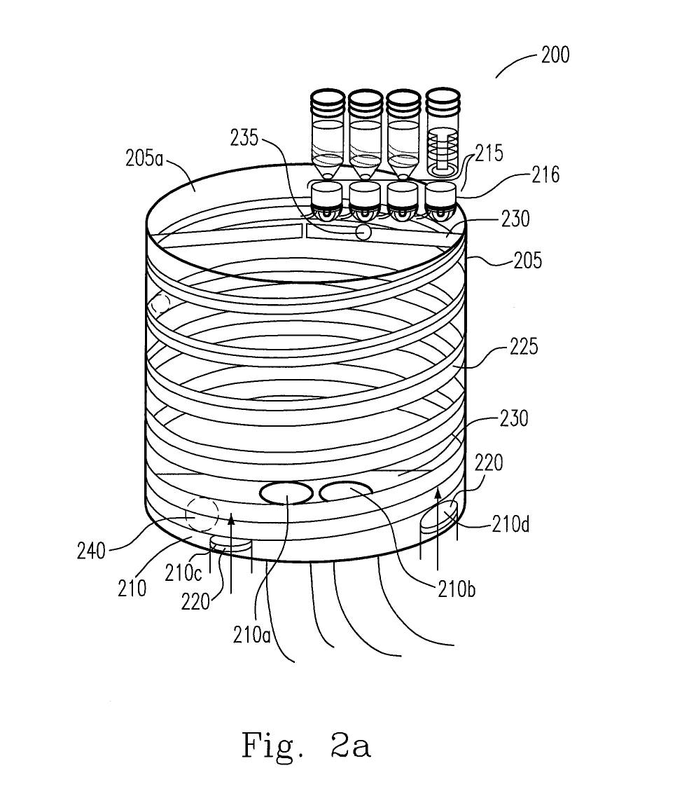

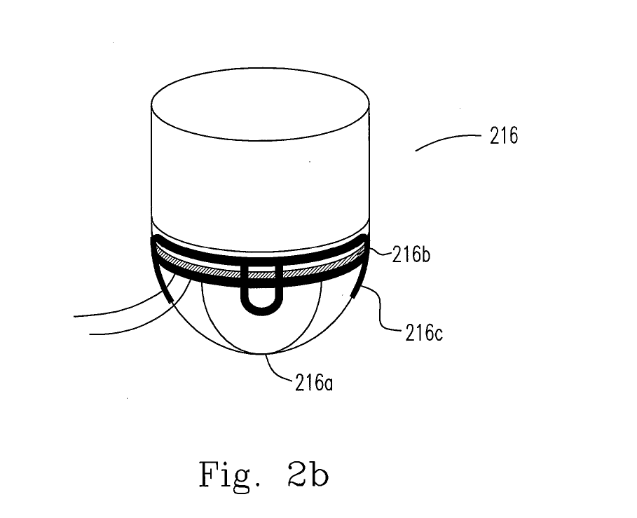

FIG. 2a is a schematic diagram illustrating a processing device in accordance with the present disclosure. In FIG. 2a, a processing device 200 includes a receiving module 215, a powder spreader 220, a slide chute 225, an extension track 230, a cylindrical chamber 205 having an inner side wall 205a and a bottom 210 having a first opening 210a, a second opening 210b, a third opening 210c and a fourth opening 210d. The slide chute 225 is spirally disposed along the inner side wall 205a. The extension track 230 is configured to extend the slide chute 225, for example, the extension track 230 is connected to an entry and an exit of the slide chute 225. The powder spreader 220 is configured on one of the third opening 210c and the fourth opening 210d for providing an environment with a plurality of pulverized edible ingredients in the cylindrical chamber 205. In some embodiments, the slide chute 225 includes a meshed housing and a solid bottom track coated with nano-particles. In some embodiments, the receiving module 215 includes a tubular barrel.

In certain embodiments of the invention, the plurality of pulverized edible ingredients is selected, for example, from a group consisting of a tapioca starch, a sweet potato flour, a custard powder, a sweet rice flour, a potato starch, a corn flour, a milk powder, a powdered cheese, a plain flour, a tea powder and the like.

FIG. 2b is a schematic diagram illustrating a tubular barrel in accordance with the present disclosure. In FIG. 2b, a tubular barrel 216 includes an openable stopper 216a, a belt heater 216b for heating the tubular barrel 216 and a reed valve 216c. The reed valve 216c is configured to close the openable stopper 216a and offer a free passage when the plunger 135d is pushed into the tubular barrel 216. In some embodiments, the processing device 200 includes two or more receiving module 215 and the receiving module 215 includes two, three, four or more tubular barrel 216.

According to certain embodiments of the invention, in order to produce an edible pellet, the filling module 120 is initially filled with ingredients. For example, an first ingredient injector filled with a first ingredient, a second ingredient injector filled with a second ingredient and a third ingredient injector filled with a third ingredient. Secondly, the filling module 120 fills the ingredients into the receiving module 215 with a filling process, for example, the first ingredient injector fills the first ingredient into the first tubular barrel, in subsequent, the motion gear moves the filling device to a predetermined position, in particular, causing the first ingredient injector to situate on top of the second tubular barrel and the second ingredient injector to situate on top of the first tubular barrel, and then the second tubular barrel is filled with the first ingredient and the first tubular barrel is filled with the second ingredient. Following the filling process, when the air injector situates on top of the first tubular barrel, the first tubular barrel is mixed with the first, second and third ingredients, and then the air injector pushes a mixed core 235 through the free passage, as shown in FIG. 2a. In some embodiments, the filling process is performed repeatedly.

According to certain embodiments of the invention, subsequent to the filling process, the mixed core 235 drops on the extension track 230, rolling in the entry of the of the slide chute 225, sliding along the slide chute 225, rolling out of the exit of the of the slide chute 225 and dropping in one of the first opening 210a and the second opening 210b. In some embodiments, since the mixed core 235 passes through the environment for attaching the plurality of pulverized edible ingredients, the mixed core 23 grows into the edible pellet 240 as shown in FIG. 2a.

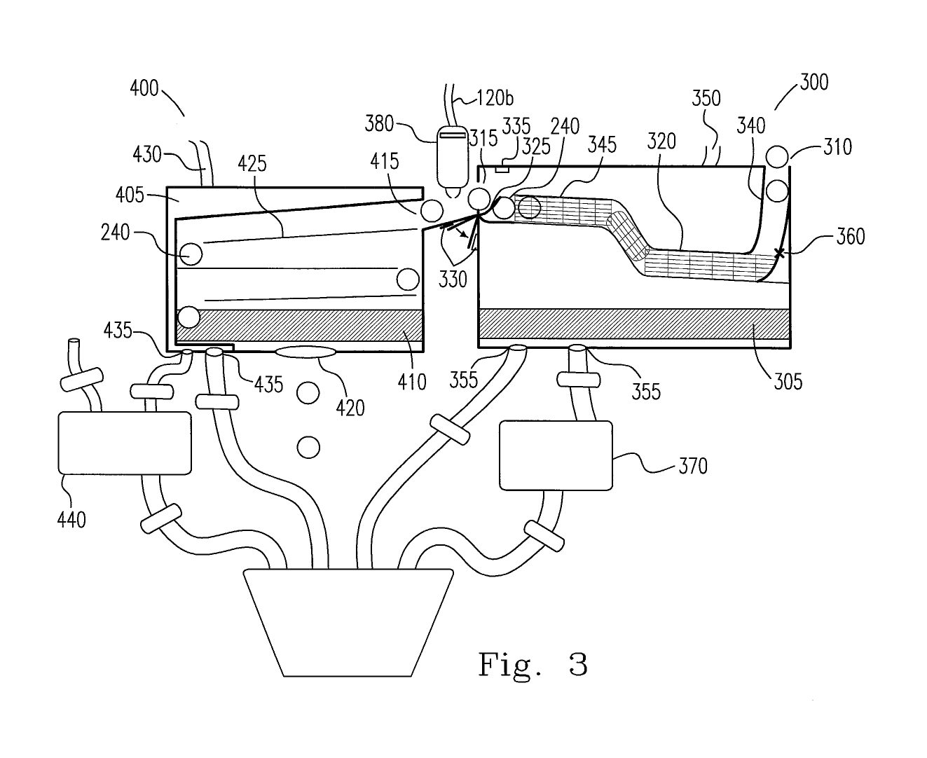

FIG. 3 is a schematic diagram illustrating a boiling tank and a cooling tank in accordance with the present disclosure. In FIG. 3, a boiling tank 300 includes a heater 305, a first opening 310, a second opening 315, a guiding pipe 320 having a front end 340 and a rear end 345, an inflow opening 350 configured to inject a hot water, an outflow opening 355 configured to drain the hot water, a cross revolving control 360, an optical sensor 335, a switchable magnetic device 330, and a flipper 325 activated by the optical sensor 335 and the switchable magnetic device 330. The first opening 310 is configured to connect to the processing device 200 by a first dispensing channel (not shown). The front end 340 is connected to the first opening 310 and the rear end 345 is in proximity to the flipper 325. In some embodiments, the boiling tank 300 includes a hard wire connected to a power system. In some embodiments, the boiling tank 300 includes two, three, four or more guiding pipe 320.

In certain embodiments of the invention, the guiding pipe 320 is fully immersed in the hot water except the rear end 345 having a bottom part slightly immersed in the hot water.

In certain embodiments of the invention, the optical sensor 335 detects a presence of the edible pellet 240 at the rear end 345 and subsequently triggers the flipper 325 to flip the edible pellet 240 into a gathering channel (not shown).

As shown in FIG. 3, a cooling tank 400 includes a water cooling system 405 having a thermoelectric cooling chip 410, a first opening 415, a second opening 420, an inflow opening 430 configured to inject a cold water, an outflow opening 435 configured to drain the cold water, and a zig-zag ramp 425. The first opening 415 is configured to connect to the boiling tank 300 by a second dispensing channel (not shown). The zig-zag ramp 425 allows the edible pellet 240 to roll down and drop through the second opening 420, so as to cause the edible pellet 240 to stay in a roundish shape and keep the edible pellet 240 separated from sticking to another edible pellet.

In certain embodiments of the invention, a first pot 370 is configured to connect to the outflow opening 355 with a valve for providing a hot tea, a coffee or a tea-mate and a second pot 440 is configured to connect to the outflow opening 435 with a valve for providing a cold tea or a tea-mate and an opening 445 connected to the external tea-mate supplier (not shown).

In certain embodiments of the invention, a coating injector 380 having an air-pumped plunger (not shown) is configured to apply a coating ingredient onto the edible pellet 240 by one of a spreading method and a dripping method. In some embodiments, the coating ingredient is a flavored syrup such as a honey syrup, a brown sugar syrup, a caramel syrup, a hazelnut syrup, a vanilla syrup, a strawberry syrup, a mocha syrup or the like. In some embodiments, the coating ingredient is an additive or the like.

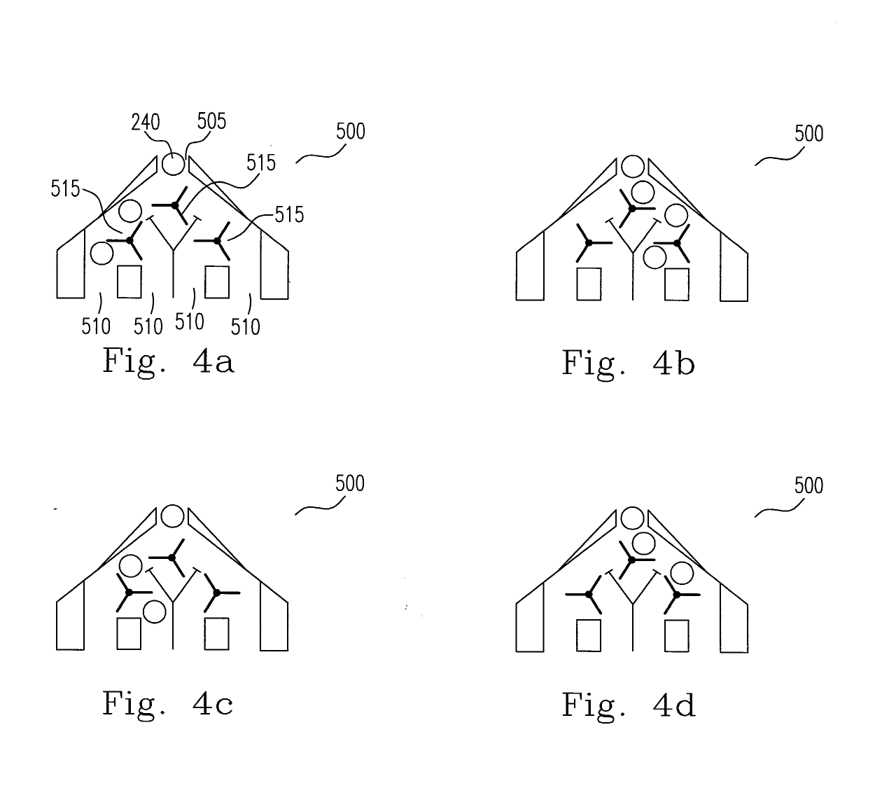

FIGS. 4a-4d are schematic diagrams illustrating operations of a funnel-shaped channel in accordance with the present disclosure. In FIGS. 4a-4d, a funnel-shaped channel 500, coated with nano-particles, includes a first opening 505 on one end, a plurality of openings 510 on another end, and a plurality of cross revolving controls 515. In some embodiments, the funnel-shaped channel 500 is a dispensing channel for performing a one-to-many distribution such that, for example, the edible pellet 240 enters the first opening 505 and exits via one of the plurality of openings 510. In some embodiments, the funnel-shaped channel 500 includes a vibrator (not shown) for moving the edible pellet 240 by a vibration method.

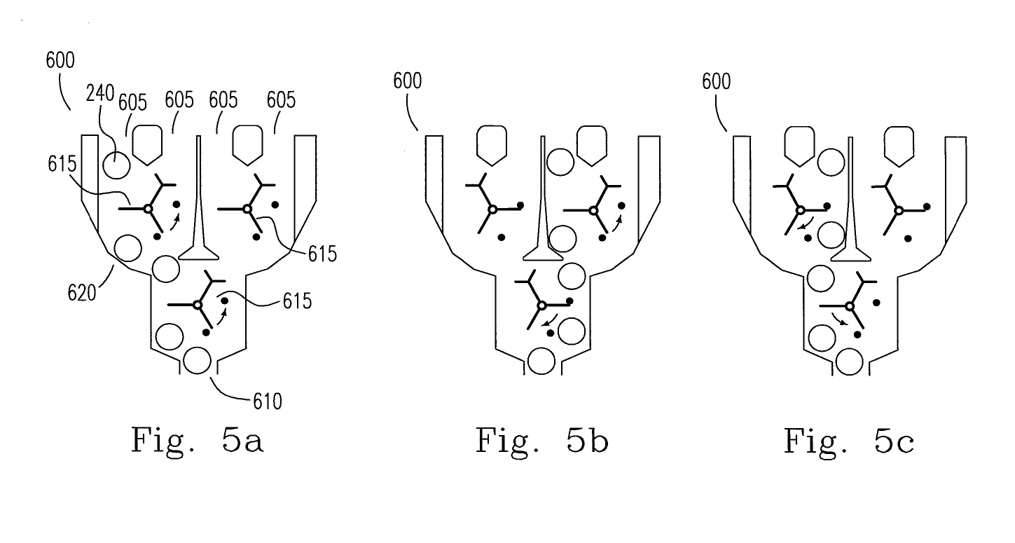

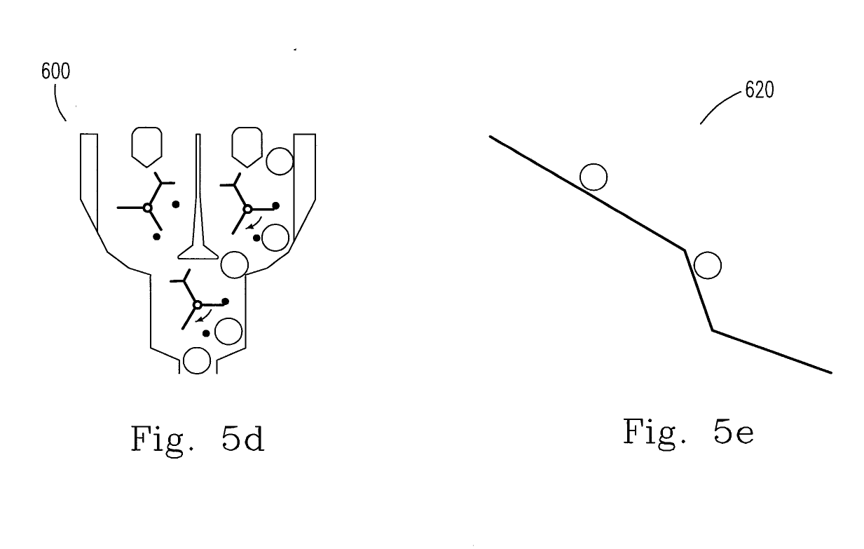

FIGS. 5a-5e are schematic diagrams illustrating operations of a funnel-shaped channel in accordance with the present disclosure. In FIGS. 5a-5e, a funnel-shaped channel 600, coated with nano-particles, includes a first opening 610 on one end, a plurality of openings 605 on another end, and a plurality of cross revolving controls 615. In some embodiments, the funnel-shaped channel 600 is a gathering channel for performing a many-to-one collection such that, for example, the edible pellet 240 enters via one of the plurality of openings 605 and exits by the first opening 610. In some embodiments, the funnel-shaped channel 600 includes a vibrator (not shown) for moving the edible pellet 240 by a vibration method. In some embodiments, a side wall 620 of the funnel-shaped channel 600 is configured in different slopes to adjust a movement of the edible pellet 240 as shown in FIG. 5e. In some embodiments, an end of each of the plurality of cross revolving controls 615 has a Y-shaped structure.

In certain embodiments of the invention, an edible pellet producing apparatus (not shown) includes the filling device 100, the processing device 200, the boiling tank 300, the cooling tank 400, the funnel-shaped channel 500, the funnel-shaped channel 600, and an electronic controller (not shown). The funnel-shaped channel 500 is disposed between the processing device 200 and the boiling tank 300. The combination of the funnel-shaped channel 500 and the funnel-shaped channel 600 is disposed between the boiling tank 300 and the cooling tank 400. Since the edible pellet producing apparatus is controlled by the electronic controller, operations of the edible pellet producing apparatus are automatic.

There are further embodiments provided as follows.

### Embodiment 1

In an edible pellet producing apparatus, the edible pellet producing apparatus includes a solidifying device and a processing chamber. The solidifying device is configured to process a plurality of edible ingredients into a moistened solid core. The processing chamber has a slide chute and is configured to receive the moistened solid core, provide an environment with a plurality of pulverized edible ingredients therein, and cause the moistened solid core to pass through the environment via the slide chute.

### Embodiment 2

In the apparatus according to the above-mentioned embodiment, apparatus further includes a coating injector, a first pot, a second pot, a plurality of valves, a boiling tank, a cooling tank, a first dispensing channel, a gathering channel, and a second dispensing channel. The boiling tank is connected to the processing chamber by the first dispensing channel. The cooling tank is connected to the boiling tank by the gathering channel and the second dispensing channel

### Embodiment 3

In the apparatus according to the above-mentioned embodiment 1 or 2, the solidifying device further includes an air pump, an air hose, a gear box with a plurality of latches, a plurality of injectors, a linear motion gear. The air hose has a first end connected to the air pump and a second end. The plurality of injectors are affixed to the gear box by the plurality of latches respectively and configured to deliver the plurality of edible ingredients. The linear motion gear is programmed to systematically move the plurality of injectors

### Embodiment 4

In the apparatus according to any one of the above-mentioned embodiments 1-3, each of the plurality of injectors further includes an upper opening connected to the second end of the air hose

### Embodiment 5

In the apparatus according to any one of the above-mentioned embodiments 1-4, at least one of the plurality of injectors further includes a lower opening with a drilled cap screwed thereon. The drilled cap includes a plurality of slots disposed around the bottom thereof.

### Embodiment 6

In the apparatus according to any one of the above-mentioned embodiments 1-5, one of the plurality of injectors further includes a plunger. The plunger is configured to provide an air pressure.

### Embodiment 7

In the apparatus according to any one of the above-mentioned embodiments 1-6, the processing chamber further includes a side wall, a first opening, a second opening, a powder spreader, and a tubular barrel. The first opening is connected to the first dispensing channel. The second opening is connected to the air hose. The powder spreader is configured on the second opening to provide the environment. The tubular barrel has an openable stopper disposed at the bottom thereof and configured to receive the plurality of edible ingredients and deliver the moistened solid core

### Embodiment 8

In the apparatus according to any one of the above-mentioned embodiments 1-7, the slide chute is spirally disposed along the side wall to receive the moistened solid core and cause the moistened solid core to pass through the environment for attaching the plurality of pulverized edible ingredients onto the moistened solid core to be grown into an edible pellet

### Embodiment 9

In the apparatus according to any one of the above-mentioned embodiments 1-8, the tubular barrel is metal and further includes a belt heater and a reed valve. The reed valve configured to close the openable stopper and offer a free passage when the air pressure is applied to the tubular barrel.

### Embodiment 10

In the apparatus according to any one of the above-mentioned embodiments 1-9, the slide chute further includes an extension track, a meshed housing, and a solid bottom. The extension track is configured to collect the moistened solid core dropped through the free passage. The solid bottom track coated with nano-particles.

### Embodiment 11

In the apparatus according to any one of the above-mentioned embodiments 1-10, the boiling tank is configured to boil an edible pellet, further includes a top, a first edge, a second edge, a side wall, a heater, a guide pipe, a first opening, a second opening, an inflow opening, an outflow opening, an optical sensor, a switchable magnetic device, and a flipper. The guide pipe has a front end and a rear end. The first opening is disposed on the top near the first edge. The second opening is situated around the sidewall near the second edge opposite to the first edge. The inflow opening is configured to inject a hot water. The outflow opening is configured to drain the hot water. The flipper is activated by the optical sensor and the switchable magnetic device

### Embodiment 12

In the apparatus according to any one of the above-mentioned embodiments 1-11, the front end of the boiling tank is connected to the first opening and the rear end is in proximity to the flipper

### Embodiment 13

In the apparatus according to any one of the above-mentioned embodiments 1-12, the guide pipe includes a guiding part, a front part, a buoying part and a rear part

### Embodiment 14

In the apparatus according to any one of the above-mentioned embodiments 1-13, each of the guiding part, the buoying part, the front part and the rear part has a bottom portion. The bottom portions of the guiding part and the bottom portion of the buoying part, and the bottom portion of the front part are fully immersed in the hot water. The bottom portion of the rear part is slightly immersed in the hot water

### Embodiment 15

In the apparatus according to any one of the above-mentioned embodiments 1-14, the optical sensor detects a presence of the edible pellet at the rear end and triggers the flipper to flip the edible pellet into the gathering channel.

### Embodiment 16

In the apparatus according to any one of the above-mentioned embodiments 1-15, the cooling tank is configured to cool down the edible pellet, further includes a water cooling system with a thermoelectric cooling chip, a first opening, a second opening, and a zig-zag ramp. The first opening is connected to the second dispensing channel. The zig-zag ramp allows the edible pellet to roll down and drop through the second opening

### Embodiment 17

In the apparatus according to any one of the above-mentioned embodiments 1-16, one of the first dispensing channel, the second dispensing channel and the gathering channel is a funnel-shaped channel coated with nano-particles.

### Embodiment 18

In the apparatus according to any one of the above-mentioned embodiments 1-17, the funnel-shaped channel further includes a vibrator, an opening on one end of the funnel-shaped channel, and a plurality of openings on another end of the funnel-shaped channel for performing one of a one-to-many distribution and a many-to-one collection.

### Embodiment 19

In an edible pellet producing apparatus, the edible pellet producing apparatus includes a processing chamber. The processing chamber has a slide chute, receiving a moistened solid core and causing the moistened solid core to be coated by a plurality of pulverized edible ingredients therein.

### Embodiment 20

In an edible pellet producing apparatus, the edible pellet producing apparatus includes a filling device and a processing chamber. The filling device provides a granule. The processing chamber is configured to process the granule into an edible pellet.

What is claimed is:

1. An edible pellet producing apparatus, comprising:
a solidifying device configured to process a plurality of edible ingredients into a moistened solid core; and
a processing chamber having a slide chute and configured to receive the moistened solid core, provide an environment with a plurality of pulverized edible ingredients therein, and cause the moistened solid core to pass through the environment via the slide chute.

2. The apparatus according to claim 1, further comprising:
a coating injector;
a first pot;
a second pot;
a plurality of valves;
a boiling tank connected to the processing chamber by a first dispensing channel; and
a cooling tank connected to the boiling tank by a gathering channel and a second dispensing channel.

3. The apparatus according to claim 2, wherein the solidifying device further comprises:
an air pump;
an air hose having a first end connected to the air pump and a second end;
a gear box with a plurality of latches;
a plurality of injectors affixed to the gear box by the plurality of latches respectively and configured to deliver the plurality of edible ingredients; and
a linear motion gear programmed to systematically move the plurality of injectors.

4. The apparatus according to claim 3, wherein each of the plurality of injectors further comprises an upper opening connected to the second end of the air hose.

5. The apparatus according to claim 4, wherein at least one of the plurality of injectors further comprises a lower opening with a drilled cap screwed thereon and the drilled cap comprises a plurality of slots disposed around the bottom thereof.

6. The apparatus according to claim 4, wherein one of the plurality of injectors further comprises a plunger configured to provide an air pressure.

7. The apparatus according to claim 6, wherein the processing chamber further comprises:
a side wall;
a first opening connected to the first dispensing channel;
a second opening connected to the air hose;
a powder spreader configured on the second opening to provide the environment; and
a tubular barrel having an openable stopper disposed at the bottom thereof and configured to receive the plurality of edible ingredients and deliver the moistened solid core.

8. The apparatus according to claim 7, wherein the slide chute is spirally disposed along the side wall to receive the moistened solid core and cause the moistened solid core to pass through the environment for attaching the plurality of pulverized edible ingredients onto the moistened solid core to be grown into an edible pellet.

9. The apparatus according to claim 8, wherein the tubular barrel is metal and further comprises:
a belt heater; and
a reed valve configured to close the openable stopper and offer a free passage when the air pressure is applied to the tubular barrel.

10. The apparatus according to claim 9, wherein the slide chute further comprises:
an extension track configured to collect the moistened solid core dropped through the free passage;
a meshed housing; and
a solid bottom track coated with nano-particles.

11. The apparatus according to claim 2, wherein the boiling tank, configured to boil an edible pellet, further comprises:
a top;
a first edge;
a second edge;
a side wall;
a heater;
a guide pipe having a front end and a rear end;
a first opening disposed on the top near the first edge;
a second opening situated around the sidewall near the second edge opposite to the first edge;
an inflow opening configured to inject a hot water;
an outflow opening configured to drain the hot water;
an optical sensor;
a switchable magnetic device; and
a flipper activated by the optical sensor and the switchable magnetic device.

12. The apparatus according to claim 11, wherein the front end is connected to the first opening, and the rear end is in proximity to the flipper.

13. The apparatus according to claim 12, wherein the guide pipe comprises a guiding part, a front part, a buoying part and a rear part.

14. The apparatus according to claim 13, wherein each of the guiding part, the buoying part, the front part and the rear part has a bottom portion, the bottom portions of the guiding part and the bottom portion of the buoying part and the bottom portion of the front part are fully immersed in the hot water, and the bottom portion of the rear part is slightly immersed in the hot water.

15. The apparatus according to claim 14, wherein the optical sensor detects a presence of the edible pellet at the rear end and triggers the flipper to flip the edible pellet into the gathering channel.

16. The apparatus according to claim 2, wherein the cooling tank, configured to cool down the edible pellet, further comprises:
a water cooling system with a thermoelectric cooling chip;
a first opening connected to the second dispensing channel;
a second opening; and
a zig-zag ramp allowing the edible pellet to roll down and drop through the second opening.

17. The apparatus according to claim 2, wherein one of the first dispensing channel, the second dispensing channel and the gathering channel is a funnel-shaped channel coated with nano-particles.

18. The apparatus according to claim 17, wherein the funnel-shaped channel further comprises:
a vibrator;
an opening on one end of the funnel-shaped channel; and
a plurality of openings on another end of the funnel-shaped channel for performing one of a one-to-many distribution and a many-to-one collection.

19. An edible pellet producing apparatus, comprising:
a processing chamber having a slide chute, receiving a moistened solid core, causing the moistened solid core to be coated by a plurality of pulverized edible ingredients therein.

20. An edible pellet producing apparatus, comprising:
a filling device providing a granule; and
a processing chamber configured to process the granule into an edible pellet.
